(19) United States
(12) Patent Application Publication
(10) Pub. No.: US 2026/0040141 A1
(43) Pub. Date: Feb. 5, 2026

(54) INFRASTRUCTURE EQUIPMENT, COMMUNICATIONS DEVICES AND METHODS

(71) Applicant: Sony Group Corporation, Tokyo (JP)

(72) Inventors: Vivek SHARMA, Basingstoke (GB); Yuxin WEI, Basingstoke (GB); Yassin Aden AWAD, Basingstoke (GB); Hideji WAKABAYASHI, Basingstoke (GB); Samuel Asangbeng ATUNGSIRI, Basingstoke (GB)

(73) Assignee: Sony Group Corporation, Tokyo (JP)

(21) Appl. No.: 18/998,216

(22) PCT Filed: Jul. 31, 2023
(86) PCT No.: PCT/EP2023/071187

§ 371 Date: Jan. 24, 2025

(30) Foreign Application Priority Data
Aug. 2, 2022 (EP) 22188398.6

(51) Int. Cl. H04W 28/06; H04L 1/1812; H04W 80/02

(52) U.S. Cl. CPC H04W 28/065; H04L 1/1812; H04W 80/02

(57) ABSTRACT

A method for operating a communications device in a wireless network involves managing application layer data as Packet Data Units (PDUs). The method includes transmitting PDUs via a physical layer while restricting transmission to the specific PDUs of a set. If a data segment fails to transmit successfully, the method terminates transmission of the remaining PDUs in the set, conserving resources and improving efficiency. Alternatively, the method provides feedback from the physical layer to higher layers, such as the PDCP layer, to terminate PDU transmission upon detecting a failure. This approach enhances reliability, reduces latency, and optimizes energy usage by preventing unnecessary retransmissions of failed PDUs or their sets. The method emphasizes resource efficiency and high-performance communication by leveraging cross-layer feedback and adaptive control.

### BACKGROUND

### Field of Disclosure

The present disclosure relates to infrastructure equipment, communications devices (user equipment) and methods for communicating data from an application layer as sets of Packet Data Units (PDUs). In one example the PDUs are in the form of Packet Data Convergence Protocol (PDCP) Packet Data Units (PDU) and transmitted using a Hybrid Automatic Repeat Request-type (HARQ) Protocol, although in other examples the PDUs are Service Data Application Protocol (SDAP) PDUs. The present disclosure claims the Paris Convention priority of European patent application number EP22188398.6 filed 2 Aug. 2022, the contents of which are incorporated by reference in their entirety.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Wireless communications networks are now supporting communications to a wider range of communications devices and user equipment for a variety of applications and data traffic profiles and types. For example, communications are now supported with devices including reduced complexity devices, machine type communication (MTC) devices, high resolution video displays, virtual reality headsets and so on. Some of these different types of devices may be deployed in very large numbers, for example low complexity devices for supporting the “The Internet of Things”, and may typically be associated with the transmissions of relatively small amounts of data with relatively high latency tolerance. Other types of device, for example supporting high-definition video streaming, may be associated with transmissions of relatively large amounts of data with relatively low latency tolerance.

In order to provide coverage for an increasing range of devices, such as IoT, 5G radio access technologies (RAT), also referred to as new radio (NR) systems, includes aspects which are devised to support connectivity over a wide range of environments. For example, a commonly used protocol for transmitting data as packets is known as the Packet Data Convergence Protocol (PDCP) which transmits data as Packet Data Units (PDUs). Furthermore, at a physical layer of transmitting data via a wireless access interface provided by such 5G/NR radio access technologies using a Hybrid Automatic Repeat Request-type (HARQ) Protocols are often used. However, combining such protocols efficiently can present technical challenges.

### SUMMARY OF THE DISCLOSURE

The present disclosure can help address or mitigate at least some of the issues discussed above.

Embodiments of the present technique can provide a method performed by a communications device to communicate data via a wireless communications network, the method comprising receiving application layer data for transmission at a protocol stack formed by the communications device for transmitting the data, the data being either received from an application layer forming part of the protocol stack as a set of Packet Data Units, PDUs, or a layer of the protocol stack being configured to form the application layer data into a set of PDUs, each PDU of the set including an indication that the PDU belongs to the set, and transmitting each of the PDUs of the set using a physical layer of the protocol stack as one or more data segments by controlling a transceiver of the communications device. The sets of PDUs may be either generated by the application layer itself or may be generated from an application layer PDU and formed into the sets of PDUs by either an PDCP layer or an SDAP layer of the protocol stack. The transmitting the PDUs of the set comprises restricting the physical layer transmission to limit the transmitting of the one or more data segments to correspond to communicating each of the PDUs of the set, and determining that one of the data segments has not been communicated successfully, and in response to determining that one of the data segments has not been transmitted successfully, terminating the transmitting of the set of PDUs, which is to communicate the application layer PDU.

According to example embodiments of a first aspect, a restriction is applied to a transmission of PDUs of a set of PDUs at the physical layer so that a failure of transmitting a physical layer data segment carrying part of one of the PDUs of the set can be used to identify that transmission of any of the remaining parts of the PDU or other PDUs of the set can be terminated, thereby saving communications resources and transmitting application layer data with a high reliability and low latency.

Embodiments of the present technique according to a second aspect can include transmitting PDUs of a set by determining that one of the physical layer data segments has not been communicated successfully, and in response to determining that one of the physical layer data segments has not been transmitted successfully, providing a feedback signal to the PDCP layer that one of the physical layer data segments has not been communicated successfully, and terminating the transmitting of the set of PDUs, which is to communicate the application layer PDU. Example embodiments can also provide as a second aspect a feedback signal from the physical layer to at least one other layer including the PDCP layer which can be used to terminate transmission of any remaining parts of a PDU and other PDUs of the PDU set thereby saving time, conserving energy and using communications resources more efficiently.

Embodiments of the present technique according to a third aspect can include transmitting each PDU of a set of PDUs using a physical layer of the protocol stack as one or more data segments by controlling a transceiver of the communications device, in which a header of each of the PDUs of the set includes a time stamp indicating a time at which the PDU set was generated for use by a receiver in discarding all of the PDUs of the set either already received or to be received, which have not been received within a time to live for the PDU set.

Respective aspects and features of the present disclosure are defined in the appended claims and include a communications device (UE), and infrastructure equipment and methods for operating the same.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of a 5G/new radio access technology (RAT) wireless communications system which may be configured to operate in accordance with embodiments of the present disclosure;

FIG. 2 is a schematic block diagram of a communications device communicating data to and/or from an infrastructure equipment (gNB) forming part of the wireless communication system shown in FIG. 1;

FIG. 3 is a schematic block diagram providing an alternative representation of the communications device and the infrastructure equipment shown in FIG. 2 showing a communication of PDCP PDUs insects of PDUs via a protocol stack in each of respectively the communications device (UE) and the infrastructure equipment (gNB) shown in FIG. 3;

FIG. 4 is an illustrative representation of operations performed to transmit an application layer PDU via the protocol stack shown in FIG. 3 from the infrastructure equipment (gNB) in the downlink to the communications device (UE) of FIG. 3;

FIG. 5 is an illustrative representation of a flow of operations performed to transmit an application layer PDU via the protocol stack shown in FIG. 3 from the communications device to the infrastructure equipment (gNB) in the uplink to the communications device (UE) of FIG. 3;

FIG. 6 is an illustrative representation of a flow of operations performed to transmit an application layer PDU via the protocol stack shown in FIG. 3 from the infrastructure equipment (gNB) in the downlink to the communications device (UE) of FIG. 3 adapted in accordance with an example embodiment of the present technique;

FIG. 7 is a part flow diagram, part schematic diagram of operations performed to transmit an application layer PDU via the protocol stack shown in FIG. 3 from the infrastructure equipment (gNB) in the downlink to the communications device (UE) adapted in accordance with an example embodiment of the present technique;

FIG. 8 is a flow diagram illustrating operations performed to transmit an application layer PDU via the protocol stack shown in FIG. 3 from the communications device (UE) in the uplink to the infrastructure equipment (gNB) adapted in accordance with an example embodiment of the present technique;

FIG. 9 is a part flow diagram, part schematic diagram of operations performed to transmit an application layer PDU via the protocol stack shown in FIG. 3 from the communications device (UE) in the uplink to the infrastructure equipment (gNB) adapted in accordance with an example embodiment of the present technique; and

FIG. 10 is a part flow diagram, part schematic diagram providing illustrative representation of operations performed to transmit an application layer PDU via protocol stacks of a communications device and an infrastructure equipment shown in FIG. 3 from the communications device (UE) in the uplink to an application layer attached to the core network via the infrastructure equipment (gNB) adapted in accordance with an example embodiment of the present technique.

### DETAILED DESCRIPTION OF THE EMBODIMENTS

### New Radio Access Technology (5G)

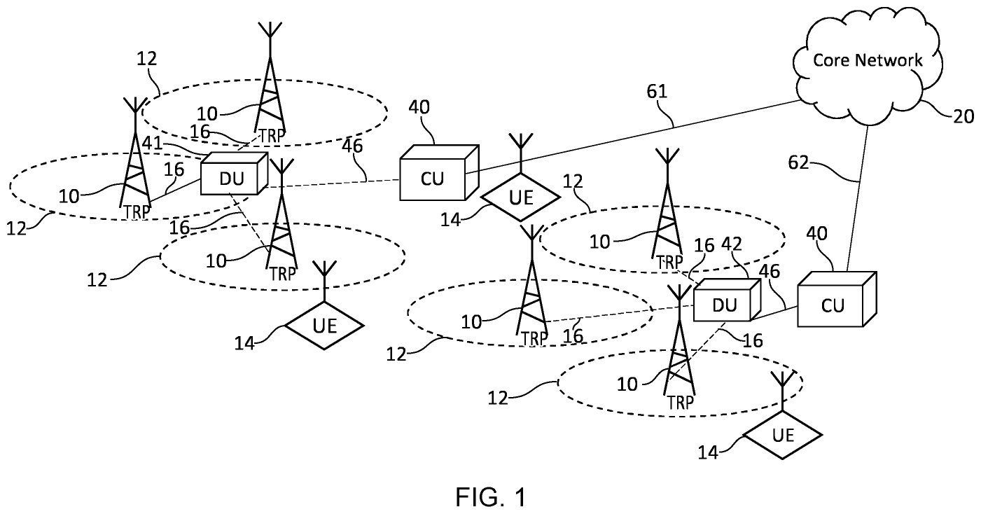

An example configuration of a wireless communications network which uses some of the terminology proposed for and used in NR and 5G is shown in FIG. 1. In FIG. 1 a plurality of transmission and reception points (TRPs) 10 are connected to distributed control units (DUs) 41, 42 by a connection interface represented as a line 16. Each of the TRPs 10 is arranged to transmit and receive signals via a wireless access interface within a radio frequency bandwidth available to the wireless communications network. Thus, within a range for performing radio communications via the wireless access interface, each of the TRPs 10, forms a cell of the wireless communications network as represented by a circle 12. As such, wireless communications devices 14 which are within a radio communications range provided by the cells 12 can transmit and receive signals to and from the TRPs 10 via the wireless access interface. Each of the distributed units 41, 42 are connected to a central unit (CU) 40 (which may be referred to as a controlling node) via an interface 46. The central unit 40 is then connected to the core network 20 which may contain all other functions required to transmit data for communicating to and from the wireless communications devices and the core network 20 may be connected to other networks 30.

As will be appreciated by those acquainted with the wireless communications network according to a 5G standard as shown in FIG. 1, the CU 40, DU 42 and TRPs 10 collectively refer to functions which are conventionally performed by a network base station or, in accordance with 5G terminology, a gNodeB (gNB). In terms of broad top-level functionality, the term network infrastructure equipment/access node may be used to encompass these elements and more conventional base station type elements of wireless telecommunications systems. Depending on the application at hand, the responsibility for scheduling transmissions which are scheduled on the radio interface between the respective DUs and the communications devices may lie with the controlling node/central unit and/or the distributed units/TRPs.

A communications device 14 is represented in FIG. 1 within the coverage area of the first communication cell 12. This communications device 14 may thus exchange signalling with the first CU 40 in the first communication cell 12 via one of the distributed units/TRPs 10 associated with the first communication cell 12. The communications devices 14 may be referred to as mobile terminals, terminals or user equipment (UE), which encompasses chip sets and have a functionality corresponding to the UE devices known for operation with wireless communications networks.

Embodiments of the present technique concern a configuration of a wireless communications network and communications devices to communicate data with a high data rate and a low latency. For example, the wireless communications network may be a 5G network shown in FIG. 1. An example of such data for communication with a high date rate and a low latency is that produced by an application layer for generating augmented reality (XR) data representing visual enhancements to viewed scenes with graphical images viewed either by a camera or a headset viewing display. Augmented reality is a known technique and has an abbreviation which will be used herein, which is XR. 3GPP projects, such as those identified in RP-213587, are exploring techniques for transmitting XR data for applications. The study is to be based on Release 17 TR 38.838, on corresponding Release 17 work from SA4 (as per SP-210043) and on Release 18 work from SA2 (as per SP-211166). Aspects being studied include:
Objectives on XR-awareness in RAN (RAN2):
   Study and identify the XR traffic (both UL and DL) characteristics, QoS metrics, and application layer attributes beneficial for the gNB to be aware of.
   Study how the above information aids XR-specific traffic handling.
Objectives on XR-specific Power Saving (RAN1, RAN2):
   Study XR specific power saving techniques to accommodate XR service characteristics (periodicity, multiple flows, jitter, latency, reliability, etc. . . . ). Focus is on the following techniques:
      C-DRX enhancement.
      PDCCH monitoring enhancement.
Objectives on XR-specific capacity improvements (RAN1, RAN2):
   Study mechanisms that provide more efficient resource allocation and scheduling for XR service characteristics (periodicity, multiple flows, jitter, latency, reliability, etc. . . . ). Focus is on the following mechanisms:
      Semi-Persistent Signalling (SPS) and Configured Grant (CG) enhancements;
      Dynamic scheduling/grant enhancements.

In order to transmit data at a high data rate with a low latency there has been proposed the concept referred to as a Packet Data Unit (PDU) set. A PDU is a packet data unit and as its name which is a unit of data transmitted using different layers of a 3GPP system including a Packet Data Convergence Protocol (PDCP) sub-layer. PDCP PDUs are transmitted between peer entities in order to ensure transmission of data serving a particular application. In order to transmit data with a high data rate and low latency such as that which may be used to serve an XR application, there has been proposed a concept of a PDU set. As specified by TS 238.700-60, which forms an SA2 specification for 3GPP, a PDU Set is composed of one or more PDUs carrying the payload of one unit of information generated at the application level (e.g. a frame or video slice for XRM Services), which are of the same importance requirement at the application layer. All PDUs in a PDU Set are needed by the application layer to be received successfully in order for any of the information of that application layer PDUs to be useful. In some cases, the application layer can still recover parts of the information unit, when some PDUs are missing. Of relevance to the present disclosure is that there has also been defined a multi-modal data, which is defined to describe input data from different kinds of devices/sensors or the output data to different kinds of destinations (e.g. one or more UEs) required for the same task or application. Multi-modal data consists of more than one Single-modal Data, and there is strong dependency among each Single-modal Data. Single-modal Data can be seen as one type of data.

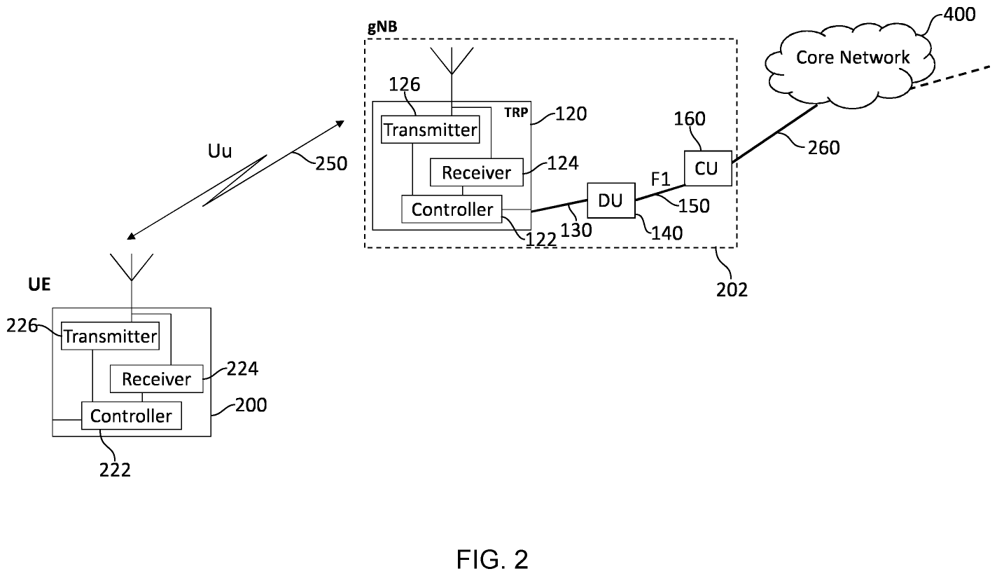

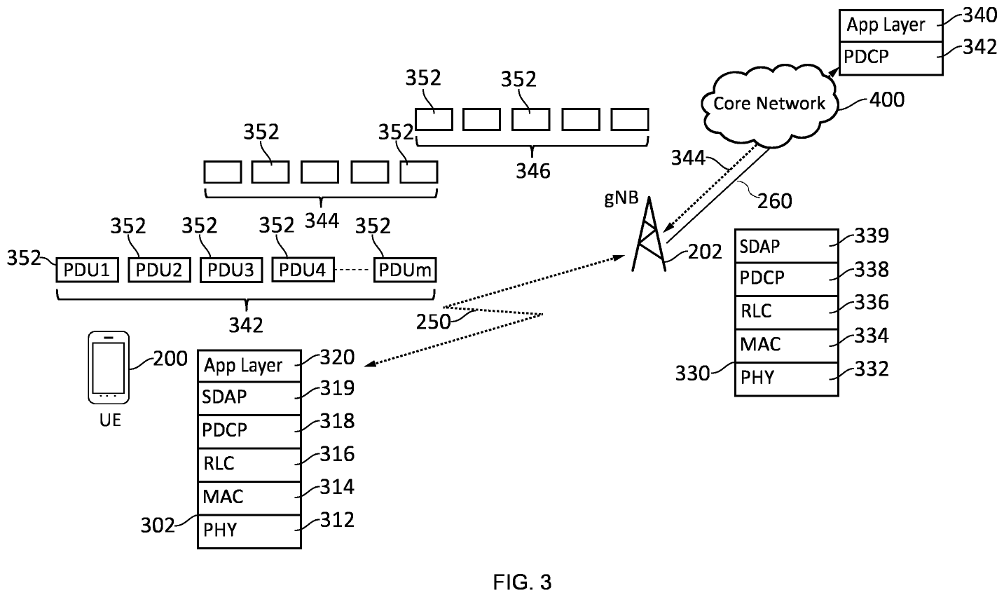

FIGS. 2 and 3 provide an example illustration in which elements of the communication system shown in FIG. 1 are configured to support an application layer program communicating data using a PDU set. Parts shown in FIG. 2 which are also shown in FIG. 1 bear the same numerical designations and so description of these parts will not be repeated for brevity.

As shown in FIGS. 2 and 3, a UE 200 transmits data from an application layer 320, which may be for example an XR application, to a gNB 202, although corresponding operations are performed for transmitting an application layer PDU on the uplink. The gNB 202 may be formed from a TRP 120, a DU 140 and the CU 160 of the wireless communications network of FIG. 1 or more particularly the radio access network. The transmission of the data at the application layer via a wireless access interface 250 uses a physical layer (PHY 212) of the wireless access interface provided by the wireless communications network as well as other players in the protocol stack as will be explained below.

FIG. 2 provides a more detailed diagram of components shown in FIG. 1. In FIG. 2, a TRP 120, which broadly corresponds to TRP 10 in FIG. 1, and comprises, as a simplified representation, a transmitter 126, a receiver 124 and a controller or controlling processor 122 which may operate to control the transmitter 126 and the receiver 124 to transmit and receive radio signals to one or more UEs within a cell (not shown in FIG. 2 for clarity) provided by the TRP 120. As shown in FIG. 2, the TRP 120 is connected to a DU 140 via a physical interface 130 which may be a fibre optic cable, for example. The physical interface 130 therefore provides a communications link for data and signalling traffic from the TRP 120 via the DU 140 and a CU 160 to a core network 400. An interface 150 between the DU 140 and the CU 160 is known as the F1 interface which can be a physical or a logical interface. The F1 interface 150 between the DU 140 and the CU 160 may operate in accordance with specifications 3GPP TS 38.470 and 3GPP TS 38.473, and may be formed from a fibre optic or other wired or wireless high bandwidth connection. The connection between a TRP 120 and the core network 400 can be generally referred to as a backhaul, which comprises the physical interface 130 from the TRP 120 to the DU 140 and the F1 interface 150 from the DU 140 to the CU 160.

As shown in FIG. 2, the TRP 120 may be configured to transmit downlink radio signals and receive uplink radio signals from a UE 200 via a direct wireless communications link 250 which may be a Uu interface in one example. The UE 200 is shown to include a transmitter 226, a receiver 224 and a controller 222 which is configured to control the transmitter 226 and the receiver 224 to transmit uplink signals to the TRP 120 and to receive downlink signals from the TRP 120 over the wireless communications link 250 formed between the UE 200 and the TRP 120.

The transmitters 126, 226 and the receivers 124, 224, as well as other transmitters, receivers and transceivers described in relation to examples and embodiments of the present disclosure may include radio frequency filters and amplifiers as well as signal processing components and devices in order to transmit and receive radio signals in accordance for example with the 5G/NR standard. The controllers 122, 222, as well as other controllers described in relation to examples and embodiments of the present disclosure may be, for example, a microprocessor, a CPU, or a dedicated chipset, etc., configured to carry out instructions which are stored on a computer readable medium, such as a non-volatile memory. The processing steps described herein may be carried out by, for example, a microprocessor in conjunction with a random access memory, operating according to instructions stored on a computer readable medium. The transmitters, the receivers and the controllers are schematically shown in FIG. 2 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s).

As mentioned above, the TRP 120, DU 140 and the CU 160 may collectively form the gNB 202 which is an example of infrastructure equipment of a wireless communications network. Therefore, references to the UE 200 communicating with the TRP 120 can alternatively be considered as references to the UE 200 communicating with the gNB 202. Furthermore, it will be appreciated that the UE 200 is an example of a communications device or wireless transceiver unit. As will be appreciated the infrastructure equipment/TRP/base station/gNB as well as the UE/communications device will in general comprise various other elements associated with its operating functionality.

According to example embodiments, a transmission of application layer data is adapted by configuring a protocol stack 302 of communications protocols either to indicate that the data being transmitted in a particular PDU belongs to a particular PDU set, or to constrain or restrict these other layers in the protocol stack to transmit data as PDUs only from a PDU set. As shown in FIG. 3, a control processor 222 (FIG. 2) of the UE 200 executes program code in order to form a protocol stack 302 which comprises a physical layer 312, a medium access control layer 314, a radio link control layer 316, a PDCP layer 318, SDAP layer 319, and an application layer 320. Correspondingly, on the network side, the gNodeB be 202 a control processor 122 executes program code to form a protocol stack 330 comprising a physical layer 332, a medium access controller 334, a radio link control layer 336, a PDCP layer 338, and an SDAP layer 339. As will be appreciated, a corresponding application layer 340 and PDCP layer 342 may be operating at a connection point in communication with the application layer 320 in the UE 200, which is connected by a packet data bearer 344 which is operating via the core network 400 using the interface 260 between the gNB 202 and the core network 400.

As will be explained in the following description, according to example embodiments, data from the application layer 320 on the UE 200 is transmitted to and received from the gNB 202 via the protocol stacks 302, 330. More particularly, data from the application layers 320, 340 is formed and transmitted as PDUs to lower layers like PDCP layer 318, 338 as a PDU sets 342, 344, 346, each PDU set comprising a plurality of m PDUs 352. As will be appreciated, PDUs are first generated in the application layer 320, 340 and then each layer, when it sends packets to its lower layer, the term PDU is used for sending packets. When a layer receives a packet from its upper layer, the term service data unit, SDU.

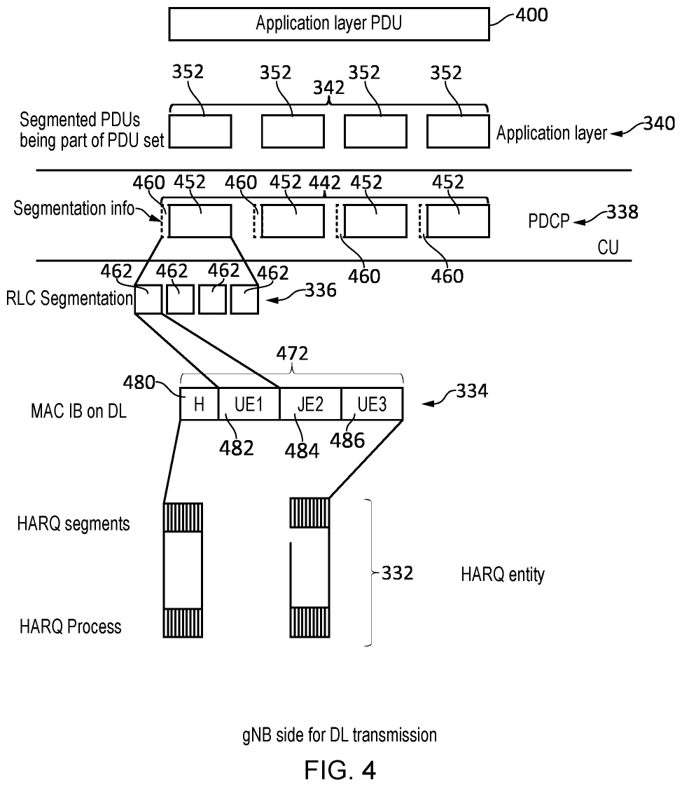

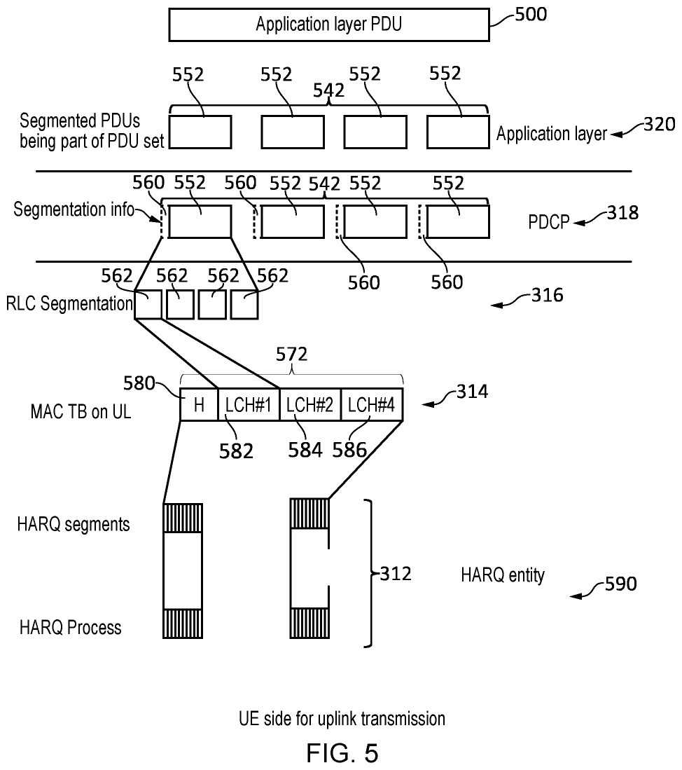

An example illustration of a conventional arrangement for transmitting application layer PDUs for the downlink, and the uplink are shown respectively in FIGS. 4 and 5. According to the example shown in FIG. 4, an application layer PDU 400, is transmitted via the protocol stack 302, 330 from the gNB 202 to the UE 200 on the downlink. As shown in FIG. 4, an example PDU set 342 generated at the application layer 340 from a PDU or set of PDUs is transmitted via the core network to the gNB and then via an SDAP layer 339, PDCP layer 338, the RLC layer 336 the MAC layer 334 and the physical layer 332. According to the example shown in FIG. 4, segment information which identifies the PDU set 442 is included in a field 460 within each of the PDCP PDUs 452 which identifies that the PDU belongs to a particular PDU set 442. Each of the PDUs 452 of the PDU set 442 is transmitted from the PDCP layer 338 as a plurality of RLC segments 462. Each of the RLC segments 462 is transmitted as a MAC transport block 472. The MAC transport blocks 472 includes a header 480 which includes the information about multiplexing of data related to different UEs in the downlink.

According to the example shown in FIG. 4, the application layer PDU 400 is transmitted from the gNB 202 to the UE 200, through the different layers of the protocol stack 302, 330 in which the PDU set 442 comprises segments of one large application layer PDU 400. As shown in FIG. 4, the application layer PDU 400 generated at an XR codec is segmented into smaller PDUs 452 of size 1500 octets in order to fit a transmission size of IP packet. An indicator may be assigned in PDCP layer 338 to indicate the segment number of application layer PDU 452. PDCP PDU 452 may then be segmented by RLC sub-layer to fit the MAC transport block (TB) 462. For downlink transmission, the gNB 202 may multiplex data from multiple UEs 482, 484, 486 in a transmission interval, which is an allocation of time for transmission of the application layer data from the wireless access interface. The MAC transport block 472 is then fed to HARQ entity 490, in which HARQ processes transmit the transport block as part segments by the transmitter under control of control circuitry of the gNB 202. According to the example shown in FIG. 4, a segment 452 of a PDU set 442 may not be traceable on lower layers due to e.g. segmentation in RLC and HARQ and then multiplexing of data in MAC sub-layer. So, in this conventional approach, a feedback for successful/unsuccessful PDU transmission/reception can be introduced in PDCP layer only and only after the PDU is processed and combined through different layers. As mentioned above, any feedback in PDCP layer may be too late because there are delays related to RTT (Round Trip Time) over the air interface, processing time in each sub-layer in the UE and gNB, transport delay between CU (PDCP) and DU (RLC, MAC) and probably RU (PHY layer).

Similarly, FIG. 5 shows transmission of application layer PDU 500 on the uplink from the UE 200 to the gNB 202. FIG. 5 provides a corresponding example for the uplink to that shown in FIG. 4 for the downlink. In FIG. 5, the application layer PDU 500 is segmented into smaller PDUs 552 of size 1500 octets in order to fit a transmission size of IP packet, and the PDUs 552 may form part of a PDU set 542. As will be explained below, example embodiments can be configured to provide an indicator, which may be assigned in the PDCP layer 318 or the SDAP layer 319, to indicate the segment number of application layer PDU 552. The PDCP PDU 552 may then be segmented by the RLC sub-layer to fit the MAC transport block 562. For uplink transmission, the UE 200 may multiplex data from different logical channels 582, 584, 586 based on an uplink grant and priority of data in a transmission interval, which is an allocation of time for transmission of the application layer data from an uplink of the wireless access interface. As for the downlink, the MAC transport block 572 is then fed to HARQ entity 590 and a HARQ process is performed by control circuitry of the UE 200, which will perform its own segmentation. Therefore, similarly for the downlink, feedback of successful application layer PDU segment can be introduced in PDCP layer, but this may already be too late to avoid wasting resources of the lower layers, and in particular the physical layer 312, if one PDU of a PDU set is unsuccessfully received.

As explained above with reference to FIGS. 2 to 4, a PDU set 342, 344, 346 contains segmented PDUs 352 of an application layer PDU 320, 340. For example, XR services can require a very high data rate and a low latency and if one PDU from this PDU set is lost then the whole PDU set may not be useful, and the remaining segments can be discarded. So, a conventional approach of waiting for feedback of a segment being successfully or unsuccessfully transmitted at higher layers may not meet a requirement for low latency and high data rate. This is because of the fact that either all segments may already have been transmitted by the transmitter or the remaining segments may exceed Packet Delay Budget (PDB) by the time feedback in an upper layer is received. A technical problem for example is to save power and/or capacity by not transmitting remaining PDUs of a PDU set if an earlier transmitted PDU in the set is not received.

There is a possibility that application layer PDUs may be transmitted across different QoS flows, which may have the same relationship as PDU sets of an application PDU e.g. I-frames in a video packet may be mapped to a separate QoS flow as compared to P-frames of a video. Additionally, audio related to a video is mapped to a separate QoS flow. A Service Data Application Protocol (SDAP) layer in RAN will then perform QoS flow to DRB mapping. In this case, either a single DRB or separate DRBs are configured. The consequence of separate DRBs for RAN may be that if I-frame is not received correctly then P-frames or related audio need to be discarded (same as PDU sets of an application PDU). So, according to example embodiments as explained below, PDU sets may be carried over a single DRB or multiple DRBs.

Example embodiments can provide a method performed by a communications device to communicate data via a wireless communications network, comprising receiving application layer data for transmission at a protocol stack formed by the communications device for transmitting the data, the data being either received from an application layer forming part of the protocol stack as a set of Packet Data Units, PDUs, or a layer of the protocol stack being configured to form the application layer data into a set of PDUs, each PDU of the set including an indication that the PDU belongs to the set, and transmitting each of the PDUs of the set using a RAN or Access Stratum protocol stack as one or more data segments by controlling a transceiver of the communications device. The transmitting the PDUs of the set comprises restricting the physical layer transmission to limit the transmitting of the one or more data segments to correspond to communicating each of the PDUs of the set, and determining that one of the data segments has not been communicated successfully, and in response to determining that one of the data segments has not been transmitted successfully, terminating the transmitting of the set of PDUs, which is to communicate the application layer PDU(s). As such, a restriction is applied to a transmission of PDUs of a set of PDUs at the physical layer so that a failure of transmitting a physical layer data segment carrying part of one of the PDUs of the set can be used to identify that transmission of any of the remaining parts of the PDU or other PDUs of the set can be terminated, thereby saving communications resources, saving energy and transmitting application layer data with a high reliability and low latency.

Example embodiments can also include determining that one of the physical layer data segments has not been communicated successfully, and in response providing a feedback signal to one or more other layers of the protocol stack that one of the physical layer data segments has not been communicated successfully, and terminating the transmitting of the set of PDUs, which is to communicate the application layer PDU. According to this example a feedback signal from the physical layer to at least one other layer, such as the PDCP layer which can be used to terminate transmission of any remaining parts of a PDU and other PDUs of the PDU set thereby saving time, conserving energy and using communications resources more efficiently.

In the following example embodiments, an example will be provided in which application layer data is generated at an application layer of a protocol stack as an application layer PDU which is received by a next layer of the protocol stack. In one example the application layer PDU includes XR data, the application layer executing an XR application. In the examples below, the application layer PDU is then received by a PDCP layer of the protocol stack as the next layer, which forms the application layer PDU into one of more sets of PDUs for transmission via the lower layers of the protocol stack as will be explained. However, in other examples the application layer data may be received by a Service Data Application Protocol (SDAP) layer as the next layer of the protocol stack for transmission via the other lower layers of the protocol stack, which may also include the PDCP layer, although in other examples the SDAP layer may pass the PDU set to the PDCP layer and then may pass the PDU set to the RLC layer. Furthermore, in some examples the application layer may form the application layer data into sets of PDUs for transmission, which are then passed to the SDAP and/or the PDCP layer for transmission via the other lower layers of the protocol stack.

Embodiments of the present technique can provide examples in which an early feedback or a solution with no feedback is provided. In order to realise lower layer feedback, as a first step the protocol stack in both the UE and correspondingly the gNB can be adapted to provide certain restrictions so that the application PDU segment is identifiable at lower layers.

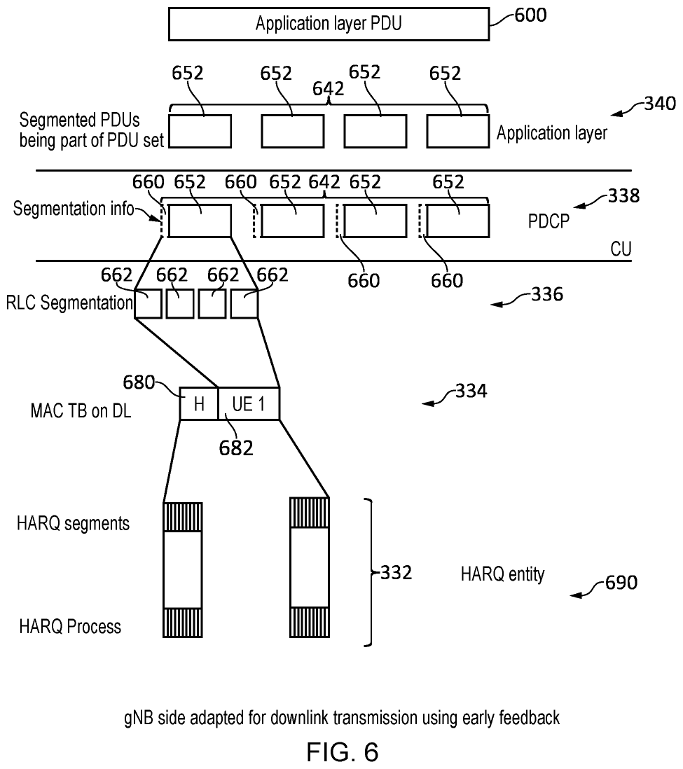

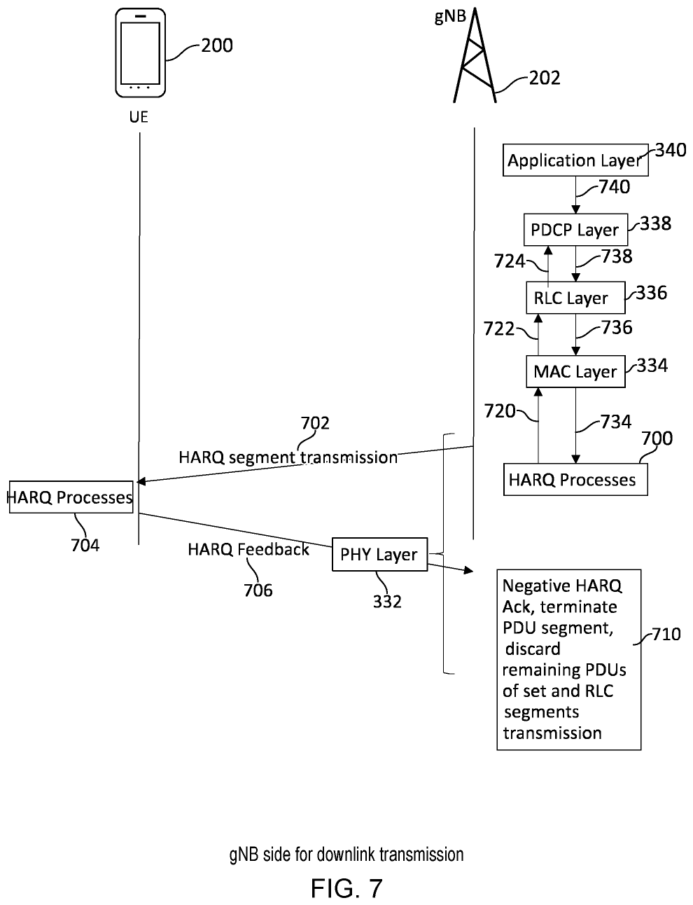

FIG. 6 provides a diagram illustrating an example embodiment in which an application layer PDU is transmitted on the downlink corresponding to the example shown in FIG. 4 in which feedback is provided from HARQ processes at the physical layer 332. Parts which also appear in FIG. 4 bear the same numerical designations. FIG. 7 provides diagram illustrating an example embodiment corresponding to the operation of FIG. 6, in which feedback is provided from the lower layers through to the PDCP layer in order to terminate transmission of a PDU set as will be explained below. As for the downlink transmission of an application layer PDU shown in FIG. 4, an application layer PDU 600 in FIG. 6 is transmitted as PDUs 652 which form one of a plurality of PDU sets 642. At the PDCP layer 338, segment information 660 is added to each of the PDUs 652 of the set 642 to identify the set to which the PDUs 652 belong. At the RLC layer 336, each PDU 652 is divided into RLC segments 662 which are then mapped onto MAC transport blocks 680. However, unlike the example shown in FIG. 4, in order to provide early feedback, the transport block 680 at the MAC layer is only directed to a single UE 682 by the gNB 202. According to example embodiments however the segment information of the PDUs 660 is carried at the RLC layer 336 and the MAC transport block 680 in a header 682 which is also conveyed to the physical layer 332. In this example the MAC transport block is restricted to carry a PDU from one UE and so failure of the transmission of that PDU or HARQ segment of this PDU can be used by the PDCP layer to terminate transmission of other PDUs in the set.

As shown in FIG. 7, where corresponding parts bear the same numerical designations, the gNB 202 transmits an application layer packet 600 to the UE 200 via the application layer 340, the PDCP layer 338, the RLC layer 336, the MAC layer 324 and the physical layer 332. According to the diagram shown in FIG. 7, the physical layer 332 is comprised of a plurality of HARQ processes 700 which are transmitting a HARQ-ACK segments by the wireless access interface 702 to receiving HARQ processes 704. In accordance with the explanation provided with reference to FIG. 6, each layer of the protocol stack 330, processes data it receives from the layer above. Starting with the application layer 340 an application layer PDU 600 is generated, which is passed to the PDCP layer 338 as represented by an arrow at 740. The PDCP layer 338 generates PDCP PDUs in sets 738 which are passed the RLC layer 336 which in turn generates RLC segments of data 736 which are passed to the MAC layer 334. The MAC layer 334 generates MAC transport blocks 734 from the RLC segments 736 and passes these to the HARQ processes 700. Each of the HARQ segments is transmitted to the UE 200 using a HARQ process 700. The receiving HARQ processes 704 receive each HARQ segment and generate a HARQ-ACK to feedback from the UE 200 to the gNB 202 as a HARQ-ACK feedback transmission 706 according to a conventional arrangement via the wireless access interface. On the transmitter side the gNB 202 includes as part of the HARQ processing a monitoring process 710. According to example embodiments if the monitoring process 710 detects a negative HARQ segment transmission, then the HARQ monitoring process 710 terminates transmission of a PDU segment, and provides a feedback signal 720 from the physical layer 332 to the MAC layer 334 in order to discard remaining transport blocks from the MAC layer. The MAC layer 334 also provides a feedback signal 722 to the RLC layer to terminate transmission of RLC segments, and a further feedback signal 724 is transmitted from the RLC layer 336 to the PDCP layer 338 to provide an indication that transmission of the remaining PDUs of the set can be terminated.

According to the example embodiments of FIGS. 6 and 7, control processing performed in the gNB 202 by the controller 122 executing program code or dedicated hardware can be adapted to include a mapping of RLC segments on a MAC transport block rather than multiplexing data of different UEs into the same transport block. At the physical layer 332, HARQ processes are pre-allocated and wait for feedback before recycling to the same HARQ process number. According to the example embodiment of FIG. 6 no HARQ enhancement is required and focus on configuration aspects. In this case, NTN procedure of no HARQ feedback signalling configuration becomes the baseline. However, it may be more restrictive for a gNB to schedule transmission of data from a single UE in a transport block even though scheduling all RLC segments may provide some compensation.

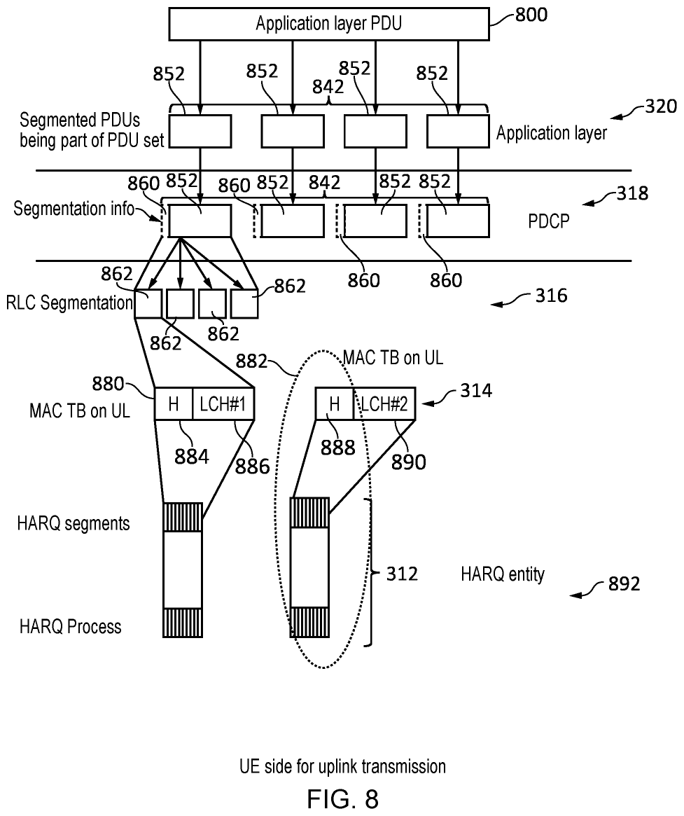

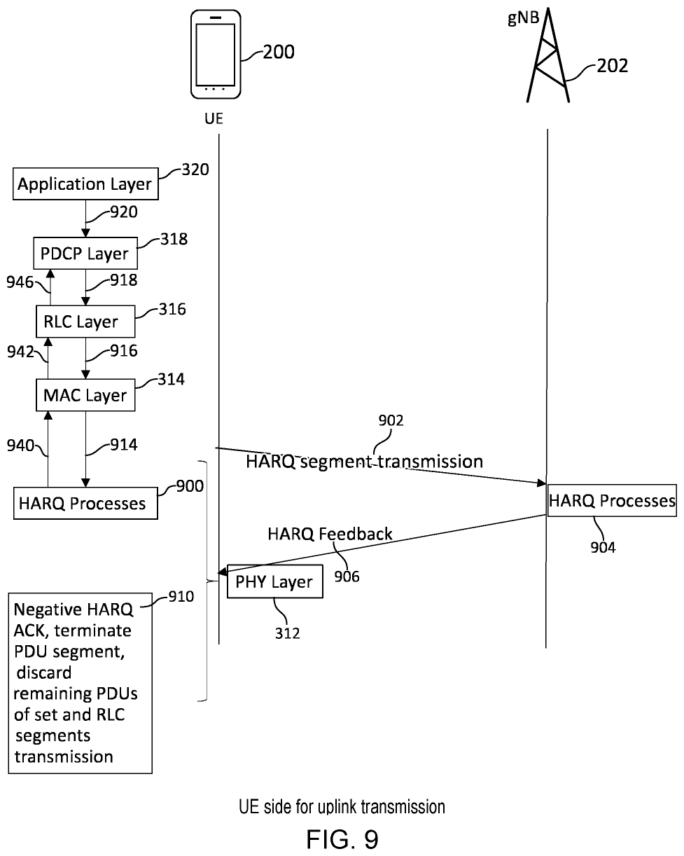

Corresponding example for uplink transmission of an application layer packet from the UE 200 to the gNB 202 as illustrated by example embodiments shown in FIGS. 8 and 9. Similar to the downlink transmission, FIG. 8 illustrates an adaptation of the protocol stack shown in FIG. 5 to restrict the lower layers of the protocol stack. In FIG. 9 a restriction is performed to ensure that a PDU set is indicated to the MAC layer, the RLC layer and the physical layer so that early feedback can be used to terminate transmission of a PDU set where one or more HARQ-ACK segments are indicated as not being received (HARQ NACK).

As shown in FIG. 8 an application layer PDU 800 is transmitted on the uplink corresponding to the example shown in FIG. 5 in which feedback is provided from a HARQ processes at the physical layer 312 of the UE 200, where the controller circuitry 222 controls the transmitter 226 and the receiver 224 to transmit data is HARQ segments under control of the controller circuitry 222 which implements the protocol stack 302 as described above. Parts which also appear in FIG. 5 bear the same numerical designations. As for the uplink transmission of an application layer PDU shown in FIG. 5, an application layer PDU 800 is transmitted as PDUs 852 which form one of a plurality of PDU sets 842. At the PDCP layer 318, segment information 860 is added to each of the PDUs 852 of the set 842 to identify the set to which the PDUs 852 belong. At the RLC layer 316, each PDU 852 is divided into RLC segments 862 which are then mapped onto MAC transport blocks 880 for uplink transmission. As explained for the transmission of an application layer PDU on the downlink of FIG. 7, in order to provide early feedback, the transport block 880 at the MAC layer is transmitted on one logical Channel so that as shown in FIG. 8 each RLC segment is formed as a MAC transport block 880, 882 and transmitted on a separate logical Channel 886, 890. Each of the MAC transport blocks 880, 882 includes a header 884, 888 which identifies the PDU and the PDU set to which the PDU belongs. According to example embodiments therefore, the segment information of the PDUs 860 is carried at the RLC layer 316 and the MAC transport block 880, 882 in the header 884, 888, which is also conveyed to the physical layer 312. Therefore, failure of the transmission of the segment of MAC transport block (HARQ segment) can be used to terminate transmission of the PDU set.

As shown in FIG. 9, where corresponding parts bear the same numerical designations, the UE 200 transmits an application layer packet 800 to the gNB 202 via the application layer 320, the SDAP layer, PDCP layer 318, the RLC layer 316, the MAC layer 314 and the physical layer 312. According to the diagram shown in FIG. 9, the physical layer 312 is comprised of a plurality of HARQ processes 900 which are transmitting a HARQ segments via the wireless access interface 902 to receiving HARQ processes 904. As for the explanation provided with reference to FIGS. 6, 7 and 8, each layer of the protocol stack 302, processes data it receives from the layer above. The application layer 320 generates an application layer PDU 800, which is passed to the PDCP layer 318 as represented by an arrow at 920. The PDCP layer 318 generates PDCP PDUs in sets 918 which are passed the RLC layer 316 which in turn generates RLC segments of data 916 which are passed to the MAC layer 314. The MAC layer 314 generates MAC transport blocks 914 from the RLC segments 916 and passes these to the HARQ processes 900. Each of the HARQ processes generates HARQ segments and each of the HARQ segments is transmitted to the UE 200 using a HARQ process 900. The receiving HARQ processes 904 receive each HARQ segment and generate a HARQ-ACK to feedback from the gNB 202 to the UE 200 as a HARQ-ACK feedback transmission 906 according to a conventional arrangement via the wireless access interface. On the transmitter side the UE 200 includes as part of the HARQ processing a monitoring process 910. According to example embodiments if the monitoring process 910 detects a negative HARQ segment transmission, then the HARQ monitoring process 910 terminates transmission of a PDU segment, and provides a feedback signal 940 from the physical layer 312 to the MAC layer 314 in order to discard remaining transport blocks from the MAC layer 314. The MAC layer 314 also provides a feedback signal 942 to the RLC layer 316 to terminate transmission of RLC segments, and a further feedback signal 946 is provided to the PDCP layer 318, which terminates transmission of the remaining PDUs of the set of PDUs of the set. The feedback is also passed to application layer to discard remaining PDUs of a PDU set.

According to the example embodiments described above, at least the RRC layer, the MAC layer and the physical layer are configured, by for example RRC signalling, such that a PDU segment is identifiable by these layers to the effect that a HARQ feedback process can provide an indication to these layers that a transmission of a PDU in a PDU set has been unsuccessful. In some examples a PDU segment may be mapped to a Dedicated Radio Bearer (DRB) and a logical channel (LCH) and a MAC transport block may contain RLC segments of the same PDCP PDU. According to these examples a HARQ process may be reserved for a particular transport block.

### Window Management

In some examples, a HARQ process may detect that a last segment of a PDU set has failed. In this example, there may be no pending action in the receiving HARQ process because all of the other HARQ segments may have been reassembled and passed onto the MAC layer as a transport block. The MAC layer may have then forwarded the RLC PDU to RLC layer. However, it may happen that these segments are still in an RLC/PDCP buffer, and it is worth propagating the feedback at HARQ layer to upper layers so that data from the RLC/PDCP buffer can be discarded. This may save unnecessary processing of packets.

There is however a need for window management to ensure that packets in a window are related to a PDU set. This sliding window mechanism will help discarding of correct packets. According to example embodiments therefore to assist in identifying a window of related segments as HARQ, MAC and RLC layers a PDCP Serial Number (SN) associated with PDUs of a PDU set or a shortened form of PDCP SN and number/location of this PDU in the PDU set is included in the PDCP header.

### Interleaving PDUs

According to some example embodiments, interleaving of PDUs can be applied from within the PDU set or across PDU sets. This approach works when a single DRB is used, and packets are shuffled around so that overall PDB is still maintained, and a feedback mechanism is still useful because there may be PDUs from PDU set still in the buffer and radio capacity is also utilised. This approach will ensure that the feedback is on time and also ensure the capacity, in terms of uplink grant and downlink scheduling is not wasted.

### Multiple TBs in One TTI

When multiple transport blocks are transmitted in a Transmission Time Interval (TTI), data belonging to different UEs can be scheduled for transmission on the downlink. For uplink transmission, a UE may send more than one transport block containing data related to different logical channels or different PDUs from either same or different PDU set.

### PDU Set Mapped to One DRB

According to some example embodiments it may be assumed that all PDUs of a PDU set may be mapped to the same DRB. Accordingly, the example embodiments can be used to define one to one mapping between a PDU session generating application PDUs where PDU is segmented and mapped to single DRB in PDCP layer. Furthermore, one DRB is mapped to one RLC channel/logical channel (except for dual connectivity) in RLC layer.

### PDU Set Mapped to More Than One DRB

According to other example embodiments, there is a possibility that PDUs in a PDU set are mapped to different DRBs. In this example there is an awareness of I/P/B frames or multi modal flows in a RAN. In this case, the identifier in a PDCP header should indicate a relationship or mapping between DRBs, for example by an associated DRB index. For example, I-frames may be mapped to one DRB and P/B-frames may be mapped to another DRB and related audio to a third DRB. In this case, an RRC signalling may assign DRB ID #6,7,8 respectively and a new PDCP entity may be created for each DRB. The PDCP header indicates, in one embodiment, an indication linking this packet to another DRB identifier (ID). So, if a packet related to DRB ID 6 has an error then there may be no point in transmitting related packets for DRB ID 7 and 8 and it is better to discard these packets. This discarding of packets should work independently on the receiver side because receiver has sufficient information to discard. The problem is to assign the relationship between PDCP SNs amongst different DRBs. One solution is to include DRB ID and PDCP SN of another DRB i.e. a packet generated for DRB ID 6 includes DRB ID 7 and related PDCP SN of PDCP SDU related to the PDCP SDU of DRB ID 6. This requires PDCP entities, created for different DRBs coordinating PDCP SNs. Alternatively, this mechanism is shifted to a Service Data Application Protocol (SDAP) layer. According to example embodiments therefore an PDCP SN is included in an associated PDU of a PDU set for one DRB case as well, but no need for DRB ID as single DRB is used.

In one embodiment, discarding takes place in PDCP layer i.e. feedback is transmitted at PDCP layer.

In another embodiment, no new configuration is introduced i.e. a MAC TB and HARQ segment may contain packets from same or different PDU set. There is no feedback mechanism introduced. However, sender PDCP layer includes a combination of the following information in each PDCP PDU:
1. Timestamp of when the packet was generated
2. Time to live for this PDU. Sender may estimate this time based on RTT, processing time for each layer in sender and receiver side (PHY, MAC, RLC sub-layer)+additional processing time and backhaul delay for CU and DU split (mainly for UL) and required packet delay budget (PDB)
3. Number of PDUs in a PDU set and the exact number/location of this particular PDU in the PDU set

Based on this information, a receiver in PDCP layer may discard earlier received PDUs of a PDU set. This approach does not stop transmission of remaining packets but allow discarding of earlier or future received packets. This may prompt the receiver not to send packets of a PDU set as radio conditions may be reciprocal for uplink and downlink. This function may also be implemented in SDAP instead of PDCP.

SDAP layer can be used for all parts related to PDCP layer.

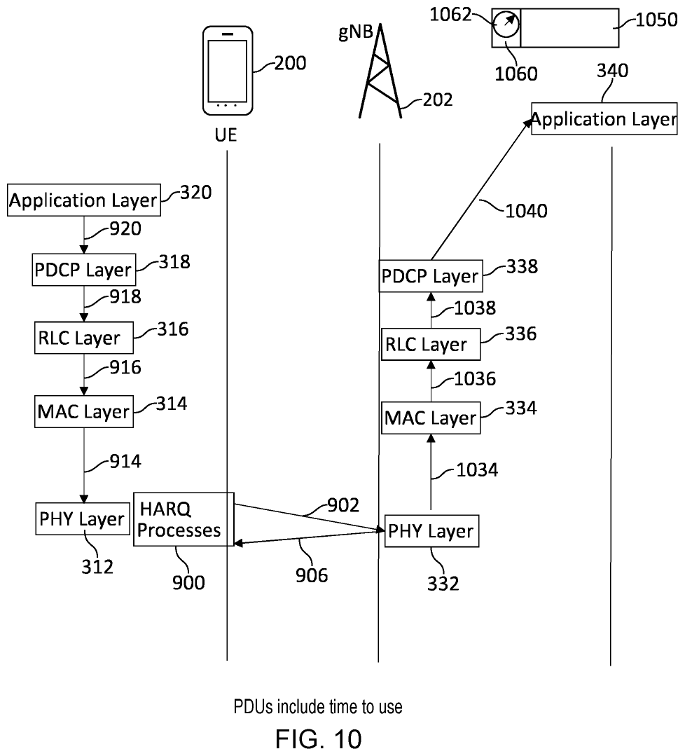

An example embodiment is shown in FIG. 10, where parts also appearing in FIGS. 3 to 9 bear the same numerical designations. As shown in FIG. 10, the UE 200 transmits an application layer packet 800 to the gNB 202 via the application layer 320, the SDAP layer 319, the PDCP layer 318, the RLC layer 316, the MAC layer 314 and the physical layer 312. As for the example embodiments already explained above, the physical layer 312 is comprised of a plurality of HARQ processes 900 which are transmitting a HARQ segments via the wireless access interface 902 to receiving HARQ processes 904. The application layer 320 generates an application layer PDU 800, which is passed to the PDCP layer 318 as represented by an arrow at 920. The PDCP layer 318 generates PDCP PDUs in sets 918 which are passed the RLC layer 316 which in turn generates RLC segments of data (or SDUs) 916 which are passed to the MAC layer 314. The MAC layer 314 generates MAC transport blocks 914 from the RLC segments 916 and passes these to the HARQ processes 900. Each of the HARQ processes generates HARQ segments and each of the HARQ segments is transmitted by the UE 200 using a HARQ process 900. The receiving HARQ processes 904 receive each HARQ segment and generate a HARQ-ACK to feedback from the gNB 202 to the UE 200 as a HARQ-ACK feedback transmission 906 according to a conventional arrangement via the wireless access interface. Correspondingly therefore on the receiver side, the gNB physical layer 332 receives the MAC transport blocks and passes 1034 each transport block to the MAC layer 324, which reforms the data segments of the RLC layer 336 (SDUs) 1036, which are passed to the RLC layer 336, which reforms PDUs which are passed 1038 to the PDCP layer 338. As shown in FIG. 10, the PDCP layer 338 then transmits 1040 the PDCP PDUs to the application layer 340 via the packet data bearer 342 as explained above.

As shown in FIG. 10 and according to this example, each of the PDUs 1050 of each set of PDUs includes a header 1060 in which is included at least an indication of a time stamp 1062 when the set of PDUs was generated. An application layer 340 can therefore determine whether any of the PDUs of a set has exceeded a used by time. If one of the PDUs is received by the application layer with a time stamp which has exceeded the use by time, the application layer can send a feedback signal to the PDCP layers 320, 338, which can in turn clear down transmission and reception of resources at each of the layers in each of the protocol stacks 320, 330 to discard data segments and data units at each layer, which been transmitted/received or are to be transmitted/received.

In other embodiments, a time stamp 1062 is maintained in PDCP/SDAP layer, which set and transmitted sent by a transmitting PDCP/SDAP entity and acted upon by a receiving PDCP/SDAP entity because the PDCP/SDAP entity can account for a radio delay. Therefore, if this is the last packet of the set, which is missing the timestamp or is received after timer expiry then the PDCP or the SDAP entity can inform the application layer to discard already received packets belonging to the same PDU set. The PDCP entity/layer already has a discard timer, which applies to overall delay and not for a PDU set. Embodiment can include a new timer/timestamp for packets belonging to a PDU set, which is used to discard all of the PDUs of the set which have exceed their time to live with respect to the timer.

As mentioned above, in some examples the header may also include an indication of a time to live, which can also be expressed as a maximum use time of the PDUs of a set of PDUs with respect to a time at which they were generated. The time to live/maximum use time can be used to determine whether a PDU of the set has exceeded a time to live/maximum use time, with respect to a time when the PDU was generated.

According to other examples, the header of the each of the PDUs of the set includes an indication of a position in the PDU set of each PDU and/or an indication of a total number of PDUs in the set. This information can be used to identify a number of PDUs of the set which have not yet been transmitted/received, and therefore whether there is a benefit to signalling to the PDCP layers 320, 330 that the set of PDUs can be discarded. For example, if the PDU of the set, that was detected to be in error/or not received, was the last PDU of the set then the application layer 340 can determine that a cost in terms of communications resources and energy consumed in signalling that the PDU set should be discarded would be greater than that gained by not transmitting/receiving PPUs of the set not so far transmitted.

In another embodiment, configuration restrictions are used with the above information is included in PDCP/SDAP header. Based on above information, PDCP may discard earlier received packets and indicate to lower layers to either provide feedback to the sender or discard next received MAC TB or data on HARQ process.

### CBG Linked to PDU Set

According to another example embodiment, one transport block can be broken down into a number of code blocks where code blocks are arranged into code block groups (CBG) based on an RRC configuration. A number of configurable CBGs per transport block can be 2, 4 and 8. If a receiver does not decode all code block groups (CBGs), it can indicate to the sender to retransmit any particular CBG in error, but not the whole transport block.

Assuming one PDU is mapped to one logical channel, multiple PDUs (from the same PDU set) corresponding to multiple logical channels can be generated, and then each logical channel can be mapped to one CBG in a transport block, hence transmitting a TB that contains single or multiple logical channels (i.e., corresponding to the same PDU set). If one CBG fails and cannot be retransmitted on time, any remaining data of the PDU set will be discarded for transmission, i.e., early termination.

According to example embodiments a logical channel can be mapped to a set of dedicated HARQ process, which is a restriction introduced for scheduling transmission of PDUs of a PDU set and then generating HARQ feedback or CBG feedback for the PDUs of the PDU set.

The following numbered paragraphs provide further example aspects and features of the present technique:

Paragraph 1. A method of communicating data by a communications device via a wireless communications network, the method comprising
receiving application layer data for transmission at a protocol stack formed by the communications device for transmitting the data, the data being either received from an application layer forming part of the protocol stack as a set of Packet Data Units, PDUs, or a layer of the protocol stack being configured to form the application layer data into a set of PDUs, each PDU of the set including an indication that the PDU belongs to the set,
transmitting each of the PDUs of the set using a physical layer of the protocol stack as one or more data segments by controlling a transceiver of the communications device, wherein the transmitting the PDUs of the set using the physical layer of the protocol stack comprises
restricting the physical layer transmission to limit the transmitting of the one or more data segments to correspond to communicating each of the PDUs of the set, and
determining that one of the data segments has not been communicated successfully, and in response to determining that one of the data segments has not been transmitted successfully, terminating the transmitting of the set of PDUs, which is to communicate the application layer PDU.

Paragraph 2. A method according to paragraph 1, comprising
receiving each of the PDUs of the PDU set at a Radio Link Control, RLC, layer of the protocol stack,
forming, at the RLC layer, for each PDU a plurality of RLC segments for transmission,
receiving each of the RLC segments at a Medium Access Control, MAC, layer,
forming, at the MAC layer, a MAC transport block from each RLC segment for transmission, and
receiving each of the MAC transport blocks at the physical layer, wherein the transmitting the PDUs of the set comprises
transmitting each MAC transport block using the physical layer by controlling the transceiver of the communications device to transmit the one or more data segments, wherein the restricting the physical layer transmission to limit the transmitting of the one or more data segments to correspond to communicating each of the PDUs of the set comprises
restricting the physical layer transmission of each MAC transport block to be transmitting of the one or more data segments to comprise data from one of the PDUs of the set.

Paragraph 3. A method according to paragraph 2, wherein the using the physical layer of the protocol stack to transmit each of the PDUs of the set comprises
performing a plurality of Hybrid Automatic Repeat Request protocol, HARQ, processes, in which the one or more data segments are a plurality of HARQ segments and each MAC transport block is divided into the plurality of HARQ segments transmitted via a wireless access interface of the wireless communications network, and the determining that one of the data segments has not been communicated successfully comprises
determining from a HARQ-ACK received in response to each transmitted HARQ segment whether the HARQ segment has been transmitted successfully or not, and the determining that one of the data segments has not been transmitted successfully,
   comprises determining from a HARQ-ACK that one of the HARQ segments has not been transmitted successfully and in response terminating the transmitting of the set of PDUs, which is to communicate the application layer PDU, failure of transmission of one HARQ segment as part of transmission of the MAC transport block indicating that the set of PDUs has been unsuccessfully communicated.

Paragraph 4. A method according to paragraph 3, wherein the restricting the physical layer transmission to limit the transmitting of the one or more data segments to correspond to communicating each of the PDUs of the set comprises restricting each MAC transport block to carry one of the RLC segments for one logical channel.

Paragraph 5. A method according to paragraph 3, comprising identifying that the HARQ-ACK segment has not been received successfully and terminating transmission of any HARQ segment for a HARQ process which has not yet been transmitted, and terminating transmission of at least part of the MAC transport block which is not yet been transmitted and terminating transmission of any RLC segment which is not yet been transmitted and terminating transmission of any PDU of the set which has not been transmitted successfully and determining that the application layer PDU has not been transmitted successfully.

Paragraph 6. A method according to paragraphs 1 or 2, wherein the using the physical layer of the protocol stack to transmit each of the PDUs of the set comprises
generating from each MAC transport block a plurality of code blocks grouped into a code block group, each MAC transport block being divided into the plurality of code blocks of a code block group and transmitted via a wireless access interface of the wireless communications network, and the determining that one of the data segments has not been communicated successfully comprises
determining from a code block has been transmitted successfully or not, and the determining that one of the data segments has not been transmitted successfully,
   comprises determining that one of the code blocks has not been transmitted successfully and in response terminating the transmitting of the set of PDUs, which is to communicate the application layer PDU.

Paragraph 7. A method according of paragraphs 1 to 6, wherein the protocol stack includes a Packet Data Convergence Protocol, PDCP, layer and the receiving the application layer data for transmission, comprises
receiving the application layer data at the PDCP layer, and
forming the application layer data into the set of PDUs.

Paragraph 8. A method according to any of paragraphs 1 to 6, wherein the protocol stack includes a Serving Data Application Protocol, SDAP, layer and the receiving the application layer data for transmission, comprises
receiving the application layer data at the SDAP layer, and
forming the application layer data into the set of PDUs.

Paragraph 9. A method of communicating data by a communications device via a wireless communications network, the method comprising
receiving application layer data for transmission at a protocol stack formed by the communications device for transmitting the data, the data being either received from an application layer forming part of the protocol stack as a set of Packet Data Units, PDUs, or another layer of the protocol stack being configured to form the application layer data into a set of PDUs, each PDU of the set including an indication that the PDU belongs to the set,
transmitting each of the PDUs of the set using a physical layer of the protocol stack as one or more data segments by controlling a transceiver of the communications device, wherein the transmitting the PDUs of the set comprises
determining that one of the physical layer data segments has not been communicated successfully, and
in response to determining that one of the physical layer data segments has not been transmitted successfully, providing a feedback signal to the application layer or the other layer of the protocol stack which formed the set of PDUs that one of the physical layer data segments has not been communicated successfully, and
terminating the transmitting of the set of PDUs at one or more layers of the protocol stack.

Paragraph 10. A method according to paragraph 9, comprising
receiving each of the PDUs of the PDU set at a Radio Link Control, RLC, layer of the protocol stack,
forming, at the RLC layer, for each PDU a plurality of RLC segments for transmission,
receiving each of the RLC segments at a Medium Access Control, MAC, layer,
forming, at the MAC layer, a MAC transport block from each RLC segment for transmission, and
receiving each of the MAC transport blocks at the physical layer, wherein the transmitting the PDUs of the set comprises
transmitting each MAC transport block using the physical layer by controlling the transceiver of the communications device to transmit the one or more data segments, wherein the providing a feedback signal to the application layer or the other layer of the protocol stack that one of the physical layer data segments has not been communicated successfully comprises
providing a feedback signal from the physical layer to the MAC layer, from the MAC layer to the RLC layer and from the RLC layer to the other layer or the application layer, and the terminating the transmitting of the set of PDUs at one or more layers of the protocol stack, includes
terminating the transmission of any remaining MAC transport block or part thereof,
terminating the transmission of any remaining RLC segment or part thereof, and
terminating the transmission of any remaining PDU of the set or part thereof.

Paragraph 11. A method according to paragraph 9 or 10, wherein the using the physical layer of the protocol stack to transmit each of the PDUs of the set comprises
performing a plurality of Hybrid Automatic Repeat Request protocol, HARQ, processes, in which the one or more data segments are a plurality of HARQ segments and each MAC transport block is divided into the plurality of HARQ segments transmitted via a wireless access interface of the wireless communications network, and the determining that one of the data segments has not been communicated successfully comprises
determining from a HARQ-ACK received in response to each transmitted HARQ segment whether the HARQ segment has been transmitted successfully or not, and the determining that one of the data segments has not been transmitted successfully, comprises determining from a HARQ-ACK that one of the HARQ segments has not been transmitted successfully and in response terminating the transmitting of the set of PDUs, which is to communicate the application layer PDU, failure of transmission of one HARQ segment as part of transmission of the MAC transport block indicating that the set of PDUs has been unsuccessfully communicated.

Paragraph 12. A method according to paragraph 11, comprising identifying that the HARQ-ACK segment has not been received successfully and terminating transmission of any HARQ segment for a HARQ process which has not yet been transmitted, and terminating transmission of at least part of the MAC transport block which is not yet been transmitted and terminating transmission of any RLC segment which is not yet been transmitted and terminating transmission of any PDU of the set which has not been transmitted successfully and determining that the application layer PDU has not been transmitted successfully.

Paragraph 13. A method according to paragraphs 9 or 10, wherein the using the physical layer of the protocol stack to transmit each of the PDUs of the set comprises
generating from each MAC transport block a plurality of code blocks grouped into a code block group, each MAC transport block being divided into the plurality of code blocks of a code block group and transmitted via a wireless access interface of the wireless communications network, and the determining that one of the data segments has not been communicated successfully comprises
determining from a code block has been transmitted successfully or not, and the determining that one of the data segments has not been transmitted successfully,
   comprises determining that one of the code blocks has not been transmitted successfully and in response terminating the transmitting of the set of PDUs, which is to communicate the application layer PDU.

Paragraph 14. A method of communicating data by a communications device via a wireless communications network, the method comprising
receiving application layer data for transmission using a protocol stack formed by the communications device for transmitting the data, the data being either received from the application layer as a set of Packet Data Units, PDUs, or a layer of the protocol stack being configured to form the application layer data into a set of PDUs, each PDU of the set including an indication that the PDU belongs to the set,
transmitting each of the PDUs of the set using a physical layer of the protocol stack as one or more data segments by controlling a transceiver of the communications device, wherein a header of each of the PDUs of the set includes a time stamp indicating a time at which the PDU set was generated for use by a receiver in discarding all of the PDUs of the set either already received or to be received, which have not been received within a time to live for the PDU set.

Paragraph 15. A method according to paragraph 14, wherein the header of the each of the PDUs of the set includes an indication of the time to live for the PDU set.

Paragraph 16. A method according to paragraph 14, wherein the header of the each of the PDUs of the set includes an indication of the time to live for that PDU of the set.

Paragraph 17. A method according to any of paragraphs 14, 15 or 16, wherein the header of the each of the PDUs of the set includes an indication of a position in the PDU set of each PDU.

Paragraph 18. A method according to any of paragraphs 14 to 17, wherein the header of the each of the PDUs of the set includes an indication of a total number of PDUs in the set.

Paragraph 19. A method of operating an infrastructure equipment forming part of a wireless communications network, the method comprising
receiving data using a protocol stack, which includes at least a physical layer in which the data is received as a plurality of data segments by controlling a transceiver of the infrastructure equipment, wherein the data comprises a set of Packet Data Units, PDUs, and a header of each of the PDUs of the set includes a time stamp indicating a time at which the PDU set was generated,
receiving an indication that at least one of the PDUs of the set has been received after a time to live, and
discarding one or more of the data segments received at the physical layer at the transceiver circuitry and one or more data segments scheduled to be received to discard all of the PDUs of the set either already received or to be received, which have not been received within a time to live for the PDU set.

Paragraph 20. A method according to paragraph 19, wherein the header of the each of the PDUs of the set includes an indication of the time to live for the PDU set.

Paragraph 21. A method according to paragraph 19, wherein the header of the each of the PDUs of the set includes an indication of the time to live for that PDU of the set.

Paragraph 22. A method according to paragraphs 19, 20 or 21, wherein the header of the each of the PDUs of the set includes an indication of a position in the PDU set of each PDU

Paragraph 23. A method according to any of paragraphs 19 to 22, wherein the header of the each of the PDUs of the set includes an indication of a total number of PDUs in the set.

Paragraph 24. A communication device for communicating data via a wireless communications network, the communications device comprising
transceiver circuitry configured to transmit data to the wireless communications network via a wireless access interface provided by the wireless communications network and to receive data from the wireless communications network transmitted via the wireless access interface, and
controller circuitry configured to control the transceiver circuitry and
   to receive application layer data for transmission at a protocol stack formed by the communications device for transmitting the data, the data being either received from an application layer forming part of the protocol stack as a set of Packet Data Units, PDUs, or a layer of the protocol stack being configured to form the application layer data into a set of PDUs, each PDU of the set including an indication that the PDU belongs to the set,
to control the transceiver circuitry to transmit each of the PDUs of the set using a physical layer of the protocol stack as one or more data segments, wherein the controller circuitry is configured to control the transceiver circuitry to transmit the PDUs of the set by
restricting the physical layer transmission to limit the transmitting of the one or more data segments to correspond to communicating each of the PDUs of the set, and
determining that one of the data segments has not been communicated successfully, and
in response to determining that one of the data segments has not been transmitted successfully, terminating the transmitting of the set of PDUs, which is to communicate the application layer PDU.

Paragraph 25. A communication device for communicating data via a wireless communications network, the communications device comprising
transceiver circuitry configured to transmit data to the wireless communications network via a wireless access interface provided by the wireless access interface and to receive data from the wireless communications network transmitted via the wireless access interface, and
controller circuitry configured to control the transceiver circuitry
to receive application layer data for transmission at a protocol stack formed by the communications device for transmitting the data, the data being either received from an application layer forming part of the protocol stack as a set of Packet Data Units, PDUs, or a layer of the protocol stack being configured to form the application layer data into a set of PDUs, each PDU of the set including an indication that the PDU belongs to the set,
to control the transceiver circuitry to transmit each of the PDUs of the set using a physical layer of the protocol stack as one or more data segments, wherein the controller circuitry is configured to control the transceiver circuitry to transmit the PDUs of the set by
determining that one of the physical layer data segments has not been communicated successfully, and
in response to determining that one of the physical layer data segments has not been transmitted successfully, providing a feedback signal to the PDCP layer that one of the physical layer data segments has not been communicated successfully, and
terminating the transmitting of the set of PDUs, which is to communicate the application layer PDU.

Paragraph 26. A method of communicating by an infrastructure equipment of a wireless communications network to communications devices, the method comprising
receiving application layer data for transmission at a protocol stack formed by the infrastructure equipment for transmitting the data, the data being either received as a set of Packet Data Units, PDUs, or a layer of the protocol stack being configured to form the application layer data into a set of PDUs, each PDU of the set including an indication that the PDU belongs to the set,
transmitting each of the PDUs of the set using a physical layer of the protocol stack as one or more data segments by controlling a transceiver of the communications device, wherein the transmitting the PDUs of the set comprises
restricting the physical layer transmission to limit the transmitting of the one or more data segments to correspond to communicating each of the PDUs of the set, and
determining that one of the data segments has not been communicated successfully, and
in response to determining that one of the data segments has not been transmitted successfully, terminating the transmitting of the set of PDUs, which is to communicate the application layer PDU.

Paragraph 27. A method of communicating by an infrastructure equipment of a wireless communications network to communications devices, the method comprising
receiving application layer data for transmission at a protocol stack formed by the infrastructure equipment for transmitting the data, the data being either received as a set of Packet Data Units, PDUs, or a layer of the protocol stack being configured to form the application layer data into a set of PDUs, each PDU of the set including an indication that the PDU belongs to the set,
transmitting each of the PDUs of the set using a physical layer of the protocol stack as one or more data segments by controlling a transceiver of the communications device, wherein the transmitting the PDUs of the set comprises
determining that one of the physical layer data segments has not been communicated successfully, and
in response to determining that one of the physical layer data segments has not been transmitted successfully, providing a feedback signal to the PDCP layer that one of the physical layer data segments has not been communicated successfully, and
terminating the transmitting of the set of PDUs, which is to communicate the application layer PDU.

Paragraph 28. An infrastructure equipment of a wireless communications network for communicating data to one or more communications devices, the infrastructure equipment comprising
transceiver circuitry configured to transmit data to the one or more communications devices via a wireless access interface formed by the infrastructure equipment, and to receive data from one or more communications devices transmitted via the wireless access interface, and
controller circuitry configured to control the transceiver circuitry and
to receive application layer data for transmission at a protocol stack formed by the infrastructure equipment for transmitting the data, the data being either received as a set of Packet Data Units, PDUs, or a layer of the protocol stack being configured to form the application layer data into a set of PDUs, each PDU of the set including an indication that the PDU belongs to the set,
to control the transceiver circuitry to transmit each of the PDUs of the set using a physical layer of the protocol stack as one or more data segments, wherein the controller circuitry is configured to control the transceiver circuitry to transmit the PDUs of the set by
restricting the physical layer transmission to limit the transmitting of the one or more data segments to correspond to communicating each of the PDUs of the set to the communications devices, and
determining that one of the data segments has not been communicated successfully, and
in response to determining that one of the data segments has not been transmitted successfully, terminating the transmitting of the set of PDUs, which is to communicate the application layer PDU.

Paragraph 29. An infrastructure equipment of a wireless communications network for communicating data to one or more communications devices, the infrastructure equipment comprising
transceiver circuitry configured to transmit data to the one or more communications devices via a wireless access interface formed by the infrastructure equipment, and to receive data from one or more communications devices transmitted via the wireless access interface, and
controller circuitry configured to control the transceiver circuitry
to receive application layer data for transmission at a protocol stack formed by the infrastructure equipment for transmitting the data, the data being either received from an application layer as a set of Packet Data Units, PDUs, or a layer of the protocol stack being configured to form the application layer data into a set of PDUs, each PDU of the set including an indication that the PDU belongs to the set,
to control the transceiver circuitry to transmit each of the PDUs of the set using a physical layer of the protocol stack as one or more data segments, wherein the controller circuitry is configured to control the transceiver circuitry to transmit the PDUs of the set by
determining that one of the physical layer data segments has not been communicated successfully, and
in response to determining that one of the physical layer data segments has not been transmitted successfully, providing a feedback signal to the PDCP layer that one of the physical layer data segments has not been communicated successfully, and
terminating the transmitting of the set of PDUs, which is to communicate the application layer PDU.

Paragraph 30. A communications device for communicating data via a wireless communications network, the communications device comprising
transceiver circuitry configured to transmit data to the wireless communications network via a wireless access interface provided by the wireless access interface and to receive data from the wireless communications network transmitted via the wireless access interface, and
controller circuitry configured to control the transceiver circuitry
to receive application layer data for transmission using a protocol stack formed by the communications device for transmitting the data, the data being either received from the application layer as a set of Packet Data Units, PDUs, or a layer of the protocol stack being configured to form the application layer data into a set of PDUs, each PDU of the set including an indication that the PDU belongs to the set, and
to transmit each of the PDUs of the set using a physical layer of the protocol stack as one or more data segments by controlling a transceiver of the communications device, wherein a header of each of the PDUs of the set includes a time stamp indicating a time at which the PDU set was generated for use by a receiver in discarding all of the PDUs of the set either already received or to be received, which have not been received within a time to live for the PDU set.

Paragraph 31. An infrastructure equipment of a wireless communications network for communicating data to one or more communications devices, the infrastructure equipment comprising
transceiver circuitry configured to transmit data to the one or more communications devices via a wireless access interface formed by the infrastructure equipment, and to receive data from one or more communications devices transmitted via the wireless access interface, and
controller circuitry configured to control the transceiver circuitry
to receive application layer data for transmission using a protocol stack formed by the infrastructure equipment for transmitting the data, the data being either received from the application layer as a set of Packet Data Units, PDUs, or a layer of the protocol stack being configured to form the application layer data into a set of PDUs, each PDU of the set including an indication that the PDU belongs to the set, and
to transmit each of the PDUs of the set using a physical layer of the protocol stack as one or more data segments by controlling a transceiver of the communications device, wherein a header of each of the PDUs of the set includes a time stamp indicating a time at which the PDU set was generated for use by a receiver in discarding all of the PDUs of the set either already received or to be received, which have not been received within a time to live for the PDU set.

Paragraph 32. A communications device for communicating data via a wireless communications network, the communications device comprising
transceiver circuitry configured to transmit data to the wireless communications network via a wireless access interface provided by the wireless access interface and to receive data from the wireless communications network transmitted via the wireless access interface, and
controller circuitry configured to control the transceiver circuitry
to receive data using a protocol stack, which includes at least a physical layer in which the data is received as a plurality of data segments by controlling a transceiver of the infrastructure equipment, wherein the data comprises a set of Packet Data Units, PDUs, and a header of each of the PDUs of the set includes a time stamp indicating a time at which the PDU set was generated,
to receive an indication that at least one of the PDUs of the set has been received after a time to live, and
to discard one or more of the data segments received at the physical layer at the transceiver circuitry and one or more data segments scheduled to be received to discard all of the PDUs of the set either already received or to be received, which have not been received within a time to live for the PDU set.

Paragraph 33. An infrastructure equipment of a wireless communications network for communicating data to one or more communications devices, the infrastructure equipment comprising
transceiver circuitry configured to transmit data to the one or more communications devices via a wireless access interface formed by the infrastructure equipment, and to receive data from one or more communications devices transmitted via the wireless access interface, and
controller circuitry configured to control the transceiver circuitry
to receive data using a protocol stack, which includes at least a physical layer in which the data is received as a plurality of data segments by controlling a transceiver of the infrastructure equipment, wherein the data comprises a set of Packet Data Units, PDUs, and a header of each of the PDUs of the set includes a time stamp indicating a time at which the PDU set was generated,
to receive an indication that at least one of the PDUs of the set has been received after a time to live, and
to discard one or more of the data segments received at the physical layer at the transceiver circuitry and one or more data segments scheduled to be received to discard all of the PDUs of the set either already received or to be received, which have not been received within a time to live for the PDU set.

Although the present disclosure has been described in connection with some embodiments, it is not intended to be limited to the specific form set forth herein. Additionally, although a feature may appear to be described in connection with particular embodiments, one skilled in the art would recognise that various features of the described embodiments may be combined in any manner suitable to implement the technique.

### REFERENCES

[1] RP-213587
[2] TR 38.838
[3] SP-210043
[4] SP-211166
[5] TS 23.700

1. A method of communicating data by a communications device via a wireless communications network, the method comprising
receiving application layer data for transmission at a protocol stack formed by the communications device for transmitting the data, the data being either received from an application layer forming part of the protocol stack as a set of Packet Data Units, PDUs, or a layer of the protocol stack being configured to form the application layer data into a set of PDUs, each PDU of the set including an indication that the PDU belongs to the set,
transmitting each of the PDUs of the set using a physical layer of the protocol stack as one or more data segments by controlling a transceiver of the communications device, wherein the transmitting the PDUs of the set using the physical layer of the protocol stack comprises
restricting the physical layer transmission to limit the transmitting of the one or more data segments to correspond to communicating each of the PDUs of the set, and
determining that one of the data segments has not been communicated successfully, and
in response to determining that one of the data segments has not been transmitted successfully, terminating the transmitting of the set of PDUs, which is to communicate the application layer PDU.

2. A method according to claim 1, comprising
receiving each of the PDUs of the PDU set at a Radio Link Control, RLC, layer of the protocol stack,
forming, at the RLC layer, for each PDU a plurality of RLC segments for transmission,
receiving each of the RLC segments at a Medium Access Control, MAC, layer,
forming, at the MAC layer, a MAC transport block from each RLC segment for transmission, and
receiving each of the MAC transport blocks at the physical layer, wherein the transmitting the PDUs of the set comprises
transmitting each MAC transport block using the physical layer by controlling the transceiver of the communications device to transmit the one or more data segments, wherein the restricting the physical layer transmission to limit the transmitting of the one or more data segments to correspond to communicating each of the PDUs of the set comprises
restricting the physical layer transmission of each MAC transport block to be transmitting of the one or more data segments to comprise data from one of the PDUs of the set.

3. A method according to claim 2, wherein the using the physical layer of the protocol stack to transmit each of the PDUs of the set comprises
performing a plurality of Hybrid Automatic Repeat Request protocol, HARQ, processes, in which the one or more data segments are a plurality of HARQ segments and each MAC transport block is divided into the plurality of HARQ segments transmitted via a wireless access interface of the wireless communications network, and the determining that one of the data segments has not been communicated successfully comprises
determining from a HARQ-ACK received in response to each transmitted HARQ segment whether the HARQ segment has been transmitted successfully or not, and the determining that one of the data segments has not been transmitted successfully, comprises determining from a HARQ-ACK that one of the HARQ segments has not been transmitted successfully and in response terminating the transmitting of the set of PDUs, which is to communicate the application layer PDU, failure of transmission of one HARQ segment as part of transmission of the MAC transport block indicating that the set of PDUs has been unsuccessfully communicated.

4. A method according to claim 3, wherein the restricting the physical layer transmission to limit the transmitting of the one or more data segments to correspond to communicating each of the PDUs of the set comprises restricting each MAC transport block to carry one of the RLC segments for one logical channel.

5. A method according to claim 3, comprising identifying that the HARQ-ACK segment has not been received successfully and terminating transmission of any HARQ segment for a HARQ process which has not yet been transmitted, and terminating transmission of at least part of the MAC transport block which is not yet been transmitted and terminating transmission of any RLC segment which is not yet been transmitted and terminating transmission of any PDU of the set which has not been transmitted successfully and determining that the application layer PDU has not been transmitted successfully.

6. A method according to claims 1, wherein the using the physical layer of the protocol stack to transmit each of the PDUs of the set comprises
generating from each MAC transport block a plurality of code blocks grouped into a code block group, each MAC transport block being divided into the plurality of code blocks of a code block group and transmitted via a wireless access interface of the wireless communications network, and the determining that one of the data segments has not been communicated successfully comprises
determining from a code block has been transmitted successfully or not, and the determining that one of the data segments has not been transmitted successfully, comprises determining that one of the code blocks has not been transmitted successfully and in response terminating the transmitting of the set of PDUs, which is to communicate the application layer PDU.

7. A method according to claim 1, wherein the protocol stack includes a Packet Data Convergence Protocol, PDCP, layer and the receiving the application layer data for transmission, comprises
receiving the application layer data at the PDCP layer, and
forming the application layer data into the set of PDUs.

8. A method according to claim 1, wherein the protocol stack includes a Serving Data Application Protocol, SDAP, layer and the receiving the application layer data for transmission, comprises
receiving the application layer data at the SDAP layer, and
forming the application layer data into the set of PDUs.

9. A method of communicating data by a communications device via a wireless communications network, the method comprising
receiving application layer data for transmission at a protocol stack formed by the communications device for transmitting the data, the data being either received from an application layer forming part of the protocol stack as a set of Packet Data Units, PDUs, or another layer of the protocol stack being configured to form the application layer data into a set of PDUs, each PDU of the set including an indication that the PDU belongs to the set,
transmitting each of the PDUs of the set using a physical layer of the protocol stack as one or more data segments by controlling a transceiver of the communications device, wherein the transmitting the PDUs of the set comprises
determining that one of the physical layer data segments has not been communicated successfully, and
in response to determining that one of the physical layer data segments has not been transmitted successfully, providing a feedback signal to the application layer or the other layer of the protocol stack which formed the set of PDUs that one of the physical layer data segments has not been communicated successfully, and
terminating the transmitting of the set of PDUs at one or more layers of the protocol stack.

10. A method according to claim 9, comprising
receiving each of the PDUs of the PDU set at a Radio Link Control, RLC, layer of the protocol stack,
forming, at the RLC layer, for each PDU a plurality of RLC segments for transmission,
receiving each of the RLC segments at a Medium Access Control, MAC, layer,
forming, at the MAC layer, a MAC transport block from each RLC segment for transmission, and
receiving each of the MAC transport blocks at the physical layer, wherein the transmitting the PDUs of the set comprises
transmitting each MAC transport block using the physical layer by controlling the transceiver of the communications device to transmit the one or more data segments, wherein the providing a feedback signal to the application layer or the other layer of the protocol stack that one of the physical layer data segments has not been communicated successfully comprises
providing a feedback signal from the physical layer to the MAC layer, from the MAC layer to the RLC layer and from the RLC layer to the other layer or the application layer, and the terminating the transmitting of the set of PDUs at one or more layers of the protocol stack, includes
terminating the transmission of any remaining MAC transport block or part thereof,
terminating the transmission of any remaining RLC segment or part thereof, and
terminating the transmission of any remaining PDU of the set or part thereof.

11. A method according to claim 9, wherein the using the physical layer of the protocol stack to transmit each of the PDUs of the set comprises
performing a plurality of Hybrid Automatic Repeat Request protocol, HARQ, processes, in which the one or more data segments are a plurality of HARQ segments and each MAC transport block is divided into the plurality of HARQ segments transmitted via a wireless access interface of the wireless communications network, and the determining that one of the data segments has not been communicated successfully comprises
determining from a HARQ-ACK received in response to each transmitted HARQ segment whether the HARQ segment has been transmitted successfully or not, and the determining that one of the data segments has not been transmitted successfully, comprises determining from a HARQ-ACK that one of the HARQ segments has not been transmitted successfully and in response terminating the transmitting of the set of PDUs, which is to communicate the application layer PDU, failure of transmission of one HARQ segment as part of transmission of the MAC transport block indicating that the set of PDUs has been unsuccessfully communicated.

12. A method according to claim 11, comprising identifying that the HARQ-ACK segment has not been received successfully and terminating transmission of any HARQ segment for a HARQ process which has not yet been transmitted, and terminating transmission of at least part of the MAC transport block which is not yet been transmitted and terminating transmission of any RLC segment which is not yet been transmitted and terminating transmission of any PDU of the set which has not been transmitted successfully and determining that the application layer PDU has not been transmitted successfully.

13. A method according to claims claim 9, wherein the using the physical layer of the protocol stack to transmit each of the PDUs of the set comprises
generating from each MAC transport block a plurality of code blocks grouped into a code block group, each MAC transport block being divided into the plurality of code blocks of a code block group and transmitted via a wireless access interface of the wireless communications network, and the determining that one of the data segments has not been communicated successfully comprises
determining from a code block has been transmitted successfully or not, and the determining that one of the data segments has not been transmitted successfully, comprises determining that one of the code blocks has not been transmitted successfully and in response terminating the transmitting of the set of PDUs, which is to communicate the application layer PDU.

14-18. (canceled)

19. A method of operating an infrastructure equipment forming part of a wireless communications network, the method comprising
receiving data using a protocol stack, which includes at least a physical layer in which the data is received as a plurality of data segments by controlling a transceiver of the infrastructure equipment, wherein the data comprises a set of Packet Data Units, PDUs, and a header of each of the PDUs of the set includes a time stamp indicating a time at which the PDU set was generated,
receiving an indication that at least one of the PDUs of the set has been received after a time to live, and
discarding one or more of the data segments received at the physical layer at the transceiver circuitry and one or more data segments scheduled to be received to discard all of the PDUs of the set either already received or to be received, which have not been received within a time to live for the PDU set.

20. A method according to claim 19, wherein the header of the each of the PDUs of the set includes an indication of the time to live for the PDU set.

21. A method according to claim 19, wherein the header of the each of the PDUs of the set includes an indication of the time to live for that PDU of the set.

22. A method according to claim 19, wherein the header of the each of the PDUs of the set includes an indication of a position in the PDU set of each PDU.

23. A method according to claim 19, wherein the header of the each of the PDUs of the set includes an indication of a total number of PDUs in the set.

24-33. (canceled)
